(19) United States
(12) Patent Application Publication
(10) Pub. No.: US 2018/0060432 A1
(43) Pub. Date: Mar. 1, 2018

(54) PRIORITIZING PEOPLE SEARCH RESULTS

(71) Applicant: Linkedln Corporation, Mountain View, CA (US)

(72) Inventors: Krishnaram Kenthapadi, Sunnyvale.., CA (US); Shakti Dhirendraji Sinha, Sunnyvale, CA (US)

(21) Appl. No.: 15/247,122

(22) Filed: Aug. 25, 2016

(51) Int. Cl. G06F 17/30; G06Q 50/00

(52) U.S. Cl. CPC G06F 17/30864; G06Q 50/01; G06F 17/30554; G06F 17/3053

(57) ABSTRACT

A search engine optimization system is provided with an on-line social network system. The on-line social network system includes or is in communication with a search engine optimization (SEO) system that is configured to prioritize people search results based on respective priority scores of the associated keywords used as search terms. The associated keywords represent respective people search results pages (PSERPs). The SEO system generates priority scores for different keyword, using a probabilistic model that takes into account a value expressing how likely the keyword is to be included in a search query as a search term and/or a value expressing how likely is a search that includes the keyword as a search term is to produce relevant results.

### TECHNICAL FIELD

This application relates to the technical fields of software and/or hardware technology and, in one example embodiment, to system and method to prioritize people search results for use in the context of an on-line social network system.

### BACKGROUND

An on-line social network may be viewed as a platform to connect people in virtual space. An on-line social network may be a web-based platform, such as, e.g., a social networking web site, and may be accessed by a use via a web browser or via a mobile application provided on a mobile phone, a tablet, etc. An on-line social network may be a business-focused social network that is designed specifically for the business community, where registered members establish and document networks of people they know and trust professionally. Each registered member may be represented by a member profile. A member profile may be represented by one or more web pages, or a structured representation of the member's information in XML (Extensible Markup Language), JSON (JavaScript Object Notation) or similar format. A member's profile web page of a social networking web site may emphasize employment history and education of the associated member.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system to prioritize people search results in an on-line social network system may be implemented;

FIG. 2 is block diagram of a system to prioritize people search results in an on-line social network system, in accordance with one example embodiment;

FIG. 3 is a flow chart illustrating a method to prioritize people search results in an on-line social network system, in accordance with an example embodiment; and

FIG. 4 is a diagrammatic representation of an example machine in the form of a computer system within which a set of instructions, for causing the machine to perform any one or more of the methodologies discussed herein, may be executed.

### DETAILED DESCRIPTION

A method and system to prioritize people search results in an on-line social network system is described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

For the purposes of this description the phrases “an on-line social networking application” and “an on-line social network system” may be referred to as and used interchangeably with the phrase “an on-line social network” or merely “a social network.” It will also be noted that an on-line social network may be any type of an on-line social network, such as, e.g., a professional network, an interest-based network, or any on-line networking system that permits users to join as registered members. For the purposes of this description, registered members of an on-line social network may be referred to as simply members.

Each member of an on-line social network is represented by a member profile (also referred to as a profile of a member or simply a profile). A member profile may be associated with social links that indicate the member's connection to other members of the social network. A member profile may also include or be associated with comments or recommendations from other members of the on-line social network, with links to other network resources, such as, e.g., publications, etc. As mentioned above, an on-line social networking system may be designed to allow registered members to establish and document networks of people they know and trust professionally. Any two members of a social network may indicate their mutual willingness to be “connected” in the context of the social network, in that they can view each other's profiles, profile recommendations and endorsements for each other and otherwise be in touch via the social network. Members that are connected in this way to a particular member may be referred to as that particular member's connections or as that particular member's network.

The profile information of a social network member may include various information such as, e.g., the name of a member, current and previous geographic location of a member, current and previous employment information of a member, information related to education of a member, information about professional accomplishments of a member, publications, patents, etc. The profile information of a social network member may also include information about the member's professional skills. A particular type of information that may be present in a profile, such as, e.g., company, industry, job position, etc., is referred to as a profile attribute. A profile attribute for a particular member profile may have one or more values. For example, a profile attribute may represent a company and be termed the company attribute. The company attribute in a particular profile may have values representing respective identifications of companies, at which the associated member has been employed. Other examples of profile attributes are the industry attribute and the region attribute. Respective values of the industry attribute and the region attribute in a member profile may indicate that the associated member is employed in the banking industry in San Francisco Bay Area.

Members may access other members' profiles by entering the name of a member represented by a member profile in the on-line social network system into the search box and examining the returned search results or by entering into a search box a phrase intended to represent a member's skill, geographic location, place of employment, etc. For example, a user may designate a search as a people search (e.g., by accessing a web page designated for people search or including a predetermined phrase, such as “working in” or “employed as,” into the search box) and enter one or more keywords, e.g., “software engineer” and “San Francisco.” A web page containing search results produced by the on-line social network system in response to a people search is referred to as a People SERP (people search results page, hereafter denoted PSERP). Another way to access members' profiles is via a people directory web page provided by the on-line social network system. A people directory web page (also referred to as a people directory) may be organized, e.g., alphabetically by keywords. The keywords may represent members' professional skills, members' geographic locations, members' places of employment (e.g., companies), etc.

While it is possible to search for people using the web pages provided by the on-line social network system, third party search engines are often used as entry points for guests to learn about the on-line social network system. It is beneficial to provide a rich people search experience for guests (users that are not members of the on-line social network system) so that they understand the value of the on-line social network system ecosystem and become members, thereby potentially driving growth and eventual monetization. Since guests often use web search as the starting point in searching in general and for people having specific professional characteristics specifically, it may be desirable that the people search results pages (PSERPs) provided by the on-line social network system are ranked such that they appear at the top of the search results list displayed to the originator of the people-related search request.

In the on-line social network system each PSERP is associated with one or more keywords that represent members' professional skills, members' geographic locations, members' places of employment (e.g., companies), etc. For example, a PSERP that includes links to member profiles that indicate that the respective members are software engineers in San Francisco may be associated in the on-line social network system with the keywords “software engineer” and “San Francisco.” A keyword that may represent a PSERP in this manner is referred to as a people-related keyword. Given hundreds of thousands of potential people-related keywords, it is beneficial to understand respective values of PSERPs relative to one another based on the respective priority values of the associated people-related keywords.

In one example embodiment, the on-line social network system includes or is in communication with a search engine optimization (SEO) system that is configured to calculate respective priority scores for people-related keywords and use these priority scores for enhancing the users' on-line people search experience. A set of keywords to be scored may be selected automatically, e.g., based on the information stored in the member profiles, and stored in a database as a bank of keywords. The SEO system may be configured to generate priority scores for different keywords, using a probabilistic model that takes into account a value expressing how likely the keyword is to be included in a search query as a search term and a value expressing how likely is a search that includes the keyword as a search term is to produce relevant results. A value expressing how likely the keyword is to be included in a search query as a search term may be referred to as a popularity score. A value expressing how likely a search that includes the keyword as a search term is to produce relevant results may be referred to as a relevance score.

Priority scores generated for people-related keywords may be used to determine relative importance of keywords within a query. For example, given a query that includes two people-related keywords: “software engineer” and “manager,” the SEO system may assign a greater weight to those search results that include or represented by the keyword “software engineer” and lesser weight to those search results that include or represented by the keyword “manager.” The search results having greater weight may be displayed more prominently in a web page that displays search results, e.g., search results having greater weight may be displayed at the top of the list of results, or in a manner that does not require a user to scroll down the page to view these search results, or in a highlighted manner, etc. Alternatively or in addition to displaying more prominently search results that have been assigned greater weight based on the priority score determined for the associated people-related keyword, the SEO system may select a greater number of the retrieved search results that include or are associated with the keyword that has a greater priority score as compared to the number of the retrieved search results that include or are associated with the keyword that has a lower priority score.

In some embodiments, the SEO system may be configured to use the respective priority scores of keywords included in a people-related search as additional signals in generating ranking scores for the search results retrieved in response to the search request. In operation, in one embodiment, the SEO system detects a query and determines that it is a people-related query. Identifying a query as being people-related could be accomplished, e.g., by detecting the presence, in the query, additional terms that have been previously identified as intent indicators, such as, e.g., the words “people” or “member,” as well as phrases such as “work as/at/in” or “who are.”

For example, suppose it is a people-related query that includes two people-related keywords: “software engineer” and “manager” that represent one or more respective PSERPs. The SEO system accesses respective associated priority scores for the keyword “software engineer” and the keyword “manager” and uses these priority scores as input to a ranking model that generates a ranking score for each search result retrieved in response to the query, together with other signals that may be indicative of relevance of a retrieved document to the issued query. Other signals used by the ranking model may be based on the content of the retrieved document, profile features of the requesting user (if the user is a member of the on-line social network system), previous interactions with the retrieved document by other members of the on-line social network system, etc. Respective ranking scores of the search results may be then used to determine which search results are to be included in a search results web page for presentation to the requesting user (e.g., these could be a certain number of top-ranking search results), to determine the manner in which the search results are displayed on a page (e.g., the results having their ranking scores above a predetermined threshold value may be visually highlighted), etc.

As mentioned above, a priority score for a keyword (that may be used as input to a ranking model for ranking search results retrieved in response to a query that includes that keyword) is generated using a probabilistic model that takes into account a value expressing how likely the keyword is to be included in a search query as a keyword (popularity score) and a value expressing how likely is a search that includes the keyword as a keyword is to produce relevant results (relevance score). In some embodiments, the priority score for a keyword is generated by multiplying the relevance score for a keyword by the popularity score for that same keyword, e.g. using Equation 1 shown below.

PrioirtyScore(w)=Pr(RELEVANT & w)=Pr(w)*Pr(RELEVANT/w), Equation (1):

where w is a keyword, Pr(w) is probability expressing the popularity score for the keyword w, and Pr(RELEVANT/w) is probability expressing the relevance score for the keyword w.

The keywords that have higher priority scores are considered to be more valuable, and, as such, can be included into the people directory and/or can be used to determine which PSERP pages to be included into a sitemap submitted to one or more third party search engines (such as, e.g., Google® or Bing®). The priority scores generated using the methodologies described herein may be also used beneficially in selecting terms for inclusion into a people directory, as explained above.

As mentioned above, a value expressing how likely the keyword is to be included in a search query as a search term is referred to as a popularity score. Popularity of a keyword provides an indication of how frequently the keyword is used in people-related searches. In order to generate popularity score Pr(w) for a particular keyword w (a subject keyword), the SEO system monitors people-related searches that include the subject keyword. In one embodiment, the SEO system monitors, for a period of time, all people-related searches performed by one or more certain target third party search engines (e.g., Google®, Yahoo!®), as well as people-related searches performed within the on-line social network system. The results of monitoring of each of these sources with respect to a particular keyword w are used to generate respective intermittent popularity values Pⱼ(w), where j is the j-th data source from k data sources. For example, Pⱼ(w) for Google® data source may be determined based on the percentage of people-related searches that include the keyword w. The intermittent popularity value Pⱼ(w) that corresponds to a third-party search volume may be designated as G(w). The intermittent popularity value Pⱼ(w) that corresponds to people search volume obtained by monitoring search requests in the on-line social network system may be designated as I(w).

When the on-line social network system is used as a data source for determining Pⱼ(w), the SEO system considers every search request to be a people-related search. When a third party search engine is used as a data source for determining Pⱼ(w), the SEO system may first determine whether the intent of the search is related to people search and take into account only those searches that have been identified as people-related, while ignoring those searches that have not been identified as people-related. Identifying a people search directed to a third party search engine as being people-related could be accomplished by detecting the presence, in a search request, of additional terms that have been identified as intent indicators, such as, e.g., the word “people” or “member,” as well as phrases such as “work as/at/in” or “who are.”

Because the popularity values generated based on data obtained from different may be in different scales, the SEO system may be configured to first normalize the intermittent popularity values Pⱼ(w) for a given keyword w, and then aggregate the normalized popularity values to arrive at the popularity score Pr(w). This approach may be expressed by Equation (2) shown below.

Pr(w)=popularityAggregateFunction(normFunction₁(P₁(w)),normFunction₂(P₂(w)), . . . ,normFunctionₖ(Pₖ(w))) Equation (2)

In one embodiment, a different normalization function is used for each of the intermittent popularity value (normFunction1 for P₁(w), normFunction2 for P₂(w), etc.). The aggregation function, denoted as popularityAggregateFunction in Equation (2) above, can be chosen to be one of max, median, mean, mean of the set of normalized popularity values selected from a certain percentile range, e.g., from 20th to 80th percentile. In some embodiments, the aggregation function can be the output of a machine learning model (such as logistic regression) that is learned over ground truth data. The normalization function normFunctionⱼ(Pⱼ(w)) is to map each of the intermittent popularity value Pⱼ(w) to the same interval.

For example, the normalization function scale (Pⱼ(w)) may map each of the intermittent popularity value Pⱼ(w) to the interval [0, 1] and utilize three percentile values—the lower threshold (α-percentile value), the median (50-percentile value), and the upper threshold (β-percentile value). The normalization function performs piecewise linear mapping from the intermittent popularity values to [0, 1]. An intermittent popularity value is mapped to 0 if it is less than the lower threshold. Linear scaling to [0, 0.5] is performed for intermittent popularity values that are greater than or equal to the lower threshold and less than or equal to the median. Linear scaling to [0.5, 1] is performed for intermittent popularity values that are greater than or equal to the median and less than or equal to the upper threshold. An intermittent popularity value is mapped to 1 if it is greater than the upper threshold. The max value from the set of normalized popularity values may then be used as the aggregation function: max(scale(P₁(w)), scale(P₂<w)), . . . , scale(Pₖ(w))). The scaling applied to each of the intermittent popularity value may be different since the percentile values could be different for each intermittent popularity type.

In some embodiments, the SEO system may be configured to use the popularity score of a keyword as the priority score for that keyword. Yet in other embodiments, as stated above, respective popularity scores generated for the keywords may be used to derive the respective corresponding priority scores, e.g., by multiplying the value expressing the popularity score by the value expressing the relevance score, as expressed by Equation (1) above.

As mentioned above, a value expressing how likely a search that includes the keyword as a search term is to produce relevant results may be referred to as a relevance score. In one embodiment, the SEO system may be configured to determine the relevance score Pr(RELEVANT/w) for a keyword w using one or multiple indicators of relevance.

One example of an indicator of relevance of a keyword is the number of people search results returned in response to a query that includes a keyword as a search term and that originates from the on-line social network system. Another indicator of relevance of a keyword may be related to respective quality scores assigned to the returned results by a third party search engine. For example, a third party search engine returns search results in response to a query that includes a keyword as a search term. The returned results each have a quality score assigned to it by the search engine. The sum of quality scores of those returned search results that originate from the on-line social network system may be used by the SEO system as one of the indicators of relevance of that keyword. Yet another indicator of relevance of a keyword may be obtained based on monitoring user engagement signals with respect to the search results returned in response to a query that includes a keyword as a search term and that originate from the on-line social network system. For example, with respect to the search results returned in response to a query that includes a keyword as a search term and that originate from the on-line social network system, the SEO system may monitor and record signals such as click through rate (CTR) and bounce rate. These signals can be aggregated over individual people results (PSERPs) to obtain a combined user engagement score for that PSERP. This user engagement score may be then utilized in deriving the relevance score for the keyword.

Another indicator of relevance of a keyword may be obtained by examining member profiles in the on-line social network system. For example, the SEO system may determine how frequently a keyword is used in a member profile to designate a skill or a job title. The intuition is that if there is a large number of professionals with a given skill/title, people are more likely to use such keywords as search terms, and are more likely to find relevant people results for such keywords.

Different indicators of relevance with respect to a particular keyword w are used to generate respective intermittent relevance values Pⱼ(RELEVANT/w), where j is the j-th data source from k data sources. Because the relevance values generated based on data obtained from different may be in different scales, the SEO system may be configured to first normalize the intermittent relevance values Pⱼ(RELEVANT/w) for a given keyword w, and then aggregate the normalized relevance values to arrive at the relevance score Pr(RELEVANT/w). This approach may be expressed by Equation (3) shown below.

Pr(RELEVANT/w)=relevanceAggregateFunction(normFunction₁(P₁(RELEVANT/w)),normFunction₂(P₂(RELEVANT/w)), . . . ,normFunction₁(P₁(RELEVANT/w))) Equation (3)

A different normalization function may be used for each of the intermittent relevance value (normFunction₁ for P₁(RELEVANT/w), normFunction2 for P₂(RELEVANT/w), etc.). Furthermore, in some embodiments, these normalization functions are also different from those used for relevance score computation. The aggregation function, denoted as relevanceAggregateFunction in Equation (3) above, can be chosen to be one of max, median, mean, mean of the set of normalized relevance values selected from a certain percentile range, e.g., from 20th to 80th percentile. In some embodiments, the aggregation function can be the output of a machine learning model (such as logistic regression) that is learned over ground truth data. In some embodiments, the normalization function normFunctionⱼ(Pⱼ(RELEVANT/w)) is to map each of the intermittent relevance value Pⱼ(RELEVANT/w) to the same interval and utilize two threshold values—the lower threshold (ε1), and the upper threshold (ε2).

For example, with respect to the intermittent Pⱼ(RELEVANT/w) is the number of search results returned in response to a query that includes a keyword as a search term that originate from the on-line social network system, the normalization function scale(Pⱼ(RELEVANT/w)) maps the people result count to [0, 1] using a step function: 0 if the people result count is fewer than the lower threshold, 1 if the people result count is greater than the upper threshold. If the people result count is greater than the lower threshold and less than the upper threshold, its normalized value is calculated as shown in Equation (4) below.

scale(Pⱼ(RELEVANT/w))=(Pⱼ(RELEVANT/w))−ε1)/(ε2−ε1) Equation (4)

In another example, where the intermittent Pⱼ(RELEVANT/w) is the sum of quality scores of those returned search results that originate from the on-line social network system, a combined quality score for the page and the keyword w is derived using an aggregation function such as max, median, mean, mean of the values between certain percentiles (e.g., from 20th to 80th percentile), etc. The aggregation function can also take into account position discounting, that is, provide greater weight to jobs search results at top positions.

Another example of the intermittent Pⱼ(RELEVANT/w) is the user feedback/engagement signals, such as, e.g., overall click through rate, bounce rate, etc. These signals can also be aggregated over individual people results to obtain combined score for the associated PSERP. Yet another example of the intermittent Pⱼ(RELEVANT/w) is the value derived from examining the member profiles and determining the frequency of appearance of the keyword w in those profiles.

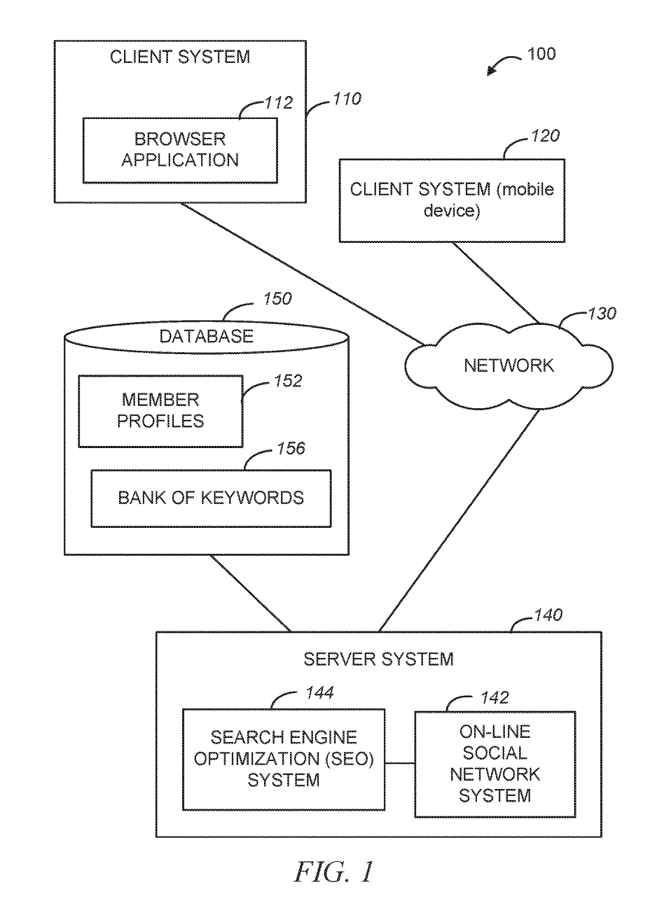

As explained above, in some embodiments, respective relevance scores generated for people-related keywords may be used to derive respective priority scores, e.g., by multiplying the value expressing the popularity score for a keyword by the value expressing the relevance score for that same keyword, as expressed by Equation (1) above. An example keyword prioritization system may be implemented in the context of a network environment 100 illustrated in FIG. 1.

As shown in FIG. 1, the network environment 100 may include client systems 110 and 120 and a server system 140. The client system 120 may be a mobile device, such as, e.g., a mobile phone or a tablet. The server system 140, in one example embodiment, may host an on-line social network system 142. As explained above, each member of an on-line social network is represented by a member profile that contains personal and professional information about the member and that may be associated with social links that indicate the member's connection to other member profiles in the on-line social network. Member profiles and related information may be stored in a database 150 as member profiles 152.

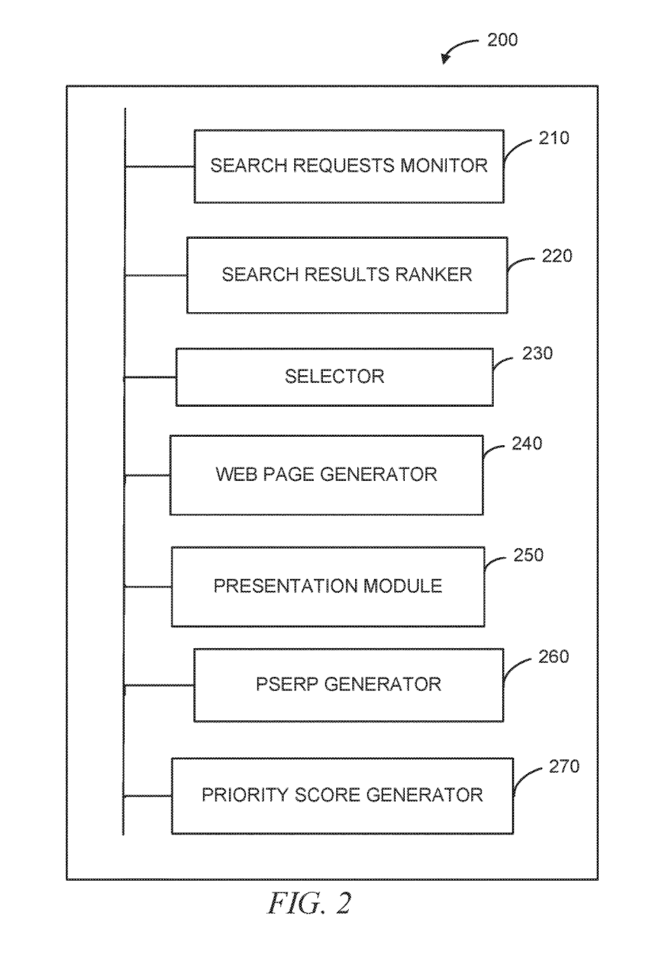

The client systems 110 and 120 may be capable of accessing the server system 140 via a communications network 130, utilizing, e.g., a browser application 112 executing on the client system 110, or a mobile application executing on the client system 120. The communications network 130 may be a public network (e.g., the Internet, a mobile communication network, or any other network capable of communicating digital data). As shown in FIG. 1, the server system 140 also hosts a search engine optimization (SEO) system 144. As explained above, the SEO system 144 may be configured to prioritize people-related keywords and also to prioritize search results retrieved in response to a people-related search request (expressed by a query). As explained above, the value of a people-related keyword is expressed as a priority score assigned to that keyword. In different embodiments the SEO system 144 generates priority scores for keywords, using a probabilistic model that takes into account a value expressing how likely the keyword is to be included in a search query as a search term and/or a value expressing how likely is a search that includes the keyword as a search term is to produce relevant results. An example keyword and search results prioritization system, which corresponds to the SEO system 144 is illustrated in FIG. 2.

FIG. 2 is a block diagram of a system 200 to prioritize people search results in an on-line social network system 142 of FIG. 1. As shown in FIG. 2, the system 200 includes a search requests monitor 210, a search results ranker 220, a selector 230, web page generator 240, a presentation module 250, a PSERP generator 260, a popularity score generator 230, a relevance score generator 240, and a priority score generator 270.

The search requests monitor 210 is configured to monitor people-related search requests. For example, the search requests monitor 210 detects a people-related search request comprising a first keyword and a second keyword, the first keyword and the second keyword representing respective first and second people search results pages (PSERPs) provided by the on-line social network system 142 of FIG. 1. The search requests monitor 210 may also monitor search requests that include a particular keyword or term that represents a PSERP. The search requests monitor 210 may select a term for using as the subject keyword in monitoring people-related search requests by accessing a PSERP, determine a term identified as representing the PSERP, and use that term as the subject keyword.

The search results ranker 220 is configured to access a first priority score assigned to the first keyword and a second priority score assigned to the second keyword, and generate respective ranking scores for search results retrieved in response to the people-related search request comprising the first keyword and the second keyword, using the first priority score assigned to the first keyword and the second priority score assigned to the second keyword. The selector 230 is configured to select a subset from the retrieved search results for presentation on a display device based on the generated respective ranking scores.

The web page generator 240 may be configured to generate a search results web page comprising the subset selected based on the generated respective ranking scores. The web page generator 240 may also be configured to generate an order of presentation of items in the subset based on their respective ranking scores. The presentation module 250 may be configured to cause presentation of the web page on a display device.

The PSERP generator 260 is configured to generate a PSERP, which is a web page that comprises references to one or more member profiles representing respective members in the on-line social network system, and selects one or more terms as representing the PSERP. A term representing the PSERP may represent a professional skill of a member (e.g., “project manager”), a geographic location of a member, a place of employment of the member (e. g., “ABC company”), etc. The PSERP generator 260 selects a term to represent the PSERP by examining member profiles referenced in the PSERP.

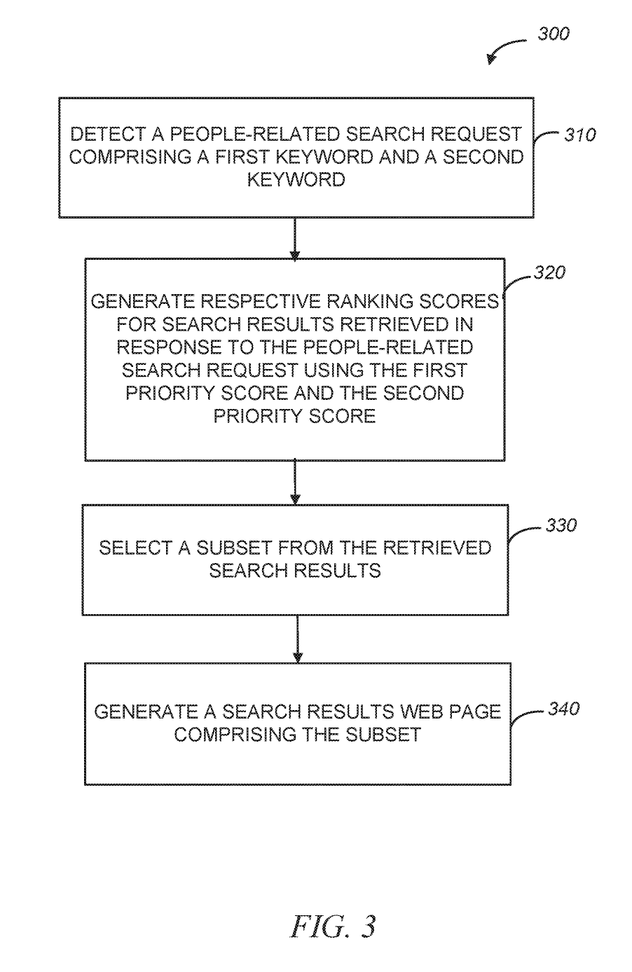

The priority score generator 270 is configured to generate a priority score for a keyword by determining a popularity score for the keyword, generating a relevance score for the keyword, and generating the priority score utilizing the popularity score and/or the relevance score. The popularity score indicates how likely the keyword is to be included in a people-related search query as a search term. The relevance score expresses how likely a search that includes the keyword as a search term is to produce a relevant result that originates from the on-line social network system 142. Some operations performed by the system 200 may be described with reference to FIG. 3.

FIG. 3 is a flow chart of a method 300 to prioritize people search results in an on-line social network system 142 of FIG. 1. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

As shown in FIG. 3, the method 300 commences at operation 310, when the search requests monitor 220 of FIG. 2 detects a people-related search request comprising a first keyword and a second keyword. The first keyword and the second keyword represent respective first and second people search results pages (PSERPs) provided by the on-line social network system 142 of FIG. 1. At operation 320, the search results ranker 220 of FIG. 2 generate respective ranking scores for search results retrieved in response to the people-related search request comprising the first keyword and the second keyword, using the first priority score assigned to the first keyword and the second priority score assigned to the second keyword. The selector 230 of FIG. 2 selects a subset from the retrieved search results for presentation on a display device, based on the generated respective ranking scores. At operation 340, the web page generator 240 of FIG. 2 generates a search results web page comprising the subset selected based on the generated respective ranking scores.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

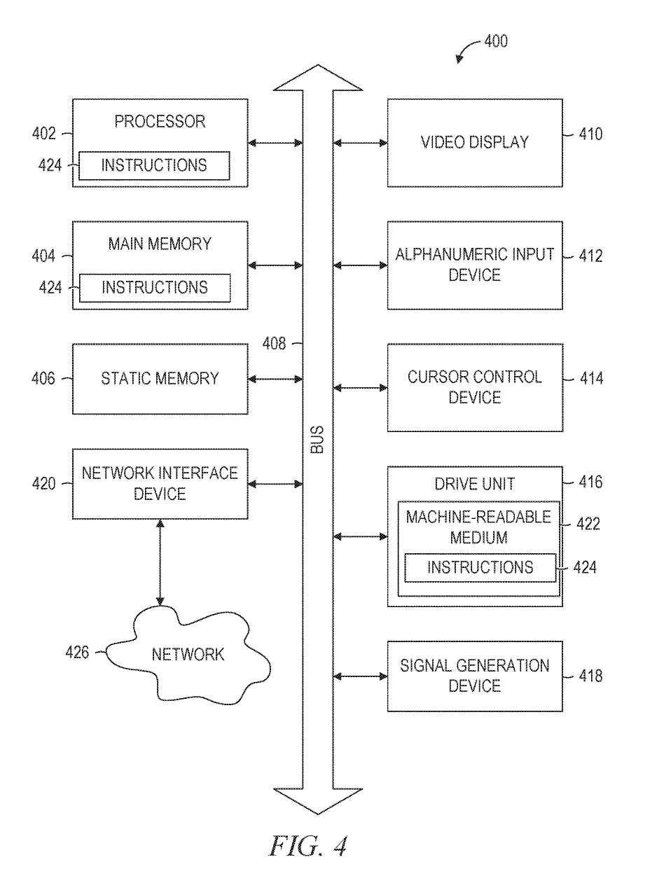

FIG. 4 is a diagrammatic representation of a machine in the example form of a computer system 400 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU), a graphics processing unit (GPU) or both), a main memory 404 and a static memory 406, which communicate with each other via a bus 404. The computer system 400 may further include a video display unit 410 (e.g., a liquid crystal display (LCD) or a cathode ray tube (CRT)). The computer system 400 also includes an alpha-numeric input device 412 (e.g., a keyboard), a user interface (UI) navigation device 414 (e.g., a cursor control device), a disk drive unit 416, a signal generation device 418 (e.g., a speaker) and a network interface device 420.

The disk drive unit 416 includes a machine-readable medium 422 on which is stored one or more sets of instructions and data structures (e.g., software 424) embodying or utilized by any one or more of the methodologies or functions described herein. The software 424 may also reside, completely or at least partially, within the main memory 404 and/or within the processor 402 during execution thereof by the computer system 400, with the main memory 404 and the processor 402 also constituting machine-readable media.

The software 424 may further be transmitted or received over a network 426 via the network interface device 420 utilizing any one of a number of well-known transfer protocols (e.g., Hyper Text Transfer Protocol (HTTP)).

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, a method and system to prioritize people search results in an on-line social network system has been described. Although embodiments have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense.

1. A computer implemented method comprising:
detecting a people-related search request comprising a first keyword and a second keyword, the first keyword and the second keyword representing respective first and second people search results pages (PSERPs) provided by an on-line social network system;
accessing a first priority score assigned to the first keyword and a second priority score assigned to the second keyword;
using at least one processor, generating respective ranking scores for search results retrieved in response to the people-related search request comprising the first keyword and the second keyword using the first priority score assigned to the first keyword and the second priority score assigned to the second keyword;
selecting a subset from the retrieved search results for presentation on a display device based on the generated respective ranking scores; and
generating a search results web page comprising the subset selected based on the generated respective ranking scores.

2. The method of claim 1, wherein the generating of the search results web page comprises generating an order of presentation of items in the subset based on their respective ranking scores, the method comprising:
causing presentation of the web page on a display device.

3. The method of claim 1, comprising:
generating the PSERP, the PRERP comprising references to one or more member profiles representing respective members in the on-line social network system;
selecting a term included in the one or more member profiles referenced in the PSERP; and
identifying the term as representing the PSERP, the term corresponding to the first keyword.

4. The method of claim 1, comprising:
accessing the PSERP; and
determining a term that represents the PSERP, the term is the first keyword.

5. The method of claim 4, wherein the term represents a place of employment.

6. The method of claim 4, wherein the term represents a professional skill.

7. The method of claim 4, wherein the term represents a geographic location.

8. The method of claim 4, comprising:
monitoring people-related search requests that include the first keyword;
determining a popularity score for the first keyword, the popularity score indicating how likely the first keyword is to be included in a people-related search query as a search term, using the monitored people-related search requests;
generating a relevance score for the first keyword, using search results produced in response to the monitored people-related search requests, the relevance score expressing how likely a search that includes the first keyword as a search term is to produce a relevant result that originates from the on-line social network system; and
generating the first priority score for the first keyword utilizing the popularity score and the relevance score.

9. The method of claim 1, wherein the search request is directed to the on-line social network system or a third party search engine, the third party search engine and the on-line social network system provided by different entities.

10. The method of claim 1, comprising determining that the search request is a people-related search request based on presence of one or more predetermined people-related search terms in the search request.

9. The method of claim 1, wherein the search request is directed to the on-line social network system or a third party search engine, the third party search engine and the on-line social network system provided by different entities.

11. A computer-implemented system comprising:
a search requests monitor, implemented using at least one processor, to detect a people-related search request comprising a first keyword and a second keyword, the first keyword and the second keyword representing respective first and second people search results pages (PSERPs) provided by an on-line social network system;
a search results ranker, implemented using at least one processor, to:
access a first priority score assigned to the first keyword and a second priority score assigned to the second keyword, and
generate respective ranking scores for search results retrieved in response to the people-related search request comprising the first keyword and the second keyword using the first priority score assigned to the first keyword and the second priority score assigned to the second keyword;
a selector, implemented using at least one processor, to select a subset from the retrieved search results for presentation on a display device based on the generated respective ranking scores; and
a web page generator, implemented using at least one processor, to generate a search results web page comprising the subset selected based on the generated respective ranking scores.

12. The system of claim 11, wherein the web page generator is to generate an order of presentation of items in the subset based on their respective ranking scores, the system comprising a presentation module to cause presentation of the web page on a display device.

13. The system of claim 11, comprising a PSERP generator, implemented using at least one processor, to:
generate the PSERP, the PRERP comprising references to one or more member profiles representing respective members in the on-line social network system,
select a term included in the one or more member profiles referenced in the PSERP; and
identify the term as representing the PSERP, the term corresponding to the first keyword.

14. The system of claim 11, wherein the PSERP generator is to:
access the PSERP; and
determine a term that represents the PSERP, the term is the first keyword.

15. The system of claim 14, wherein the term represents a place of employment.

16. The system of claim 14, wherein the term represents a professional skill.

17. The system of claim 14, wherein the term represents a geographic location.

18. The system of claim 14, wherein the search requests monitor to monitor people-related search requests that include the first keyword, the system comprising a priority score generator to:
determine a popularity score for the first keyword, the popularity score indicating how likely the first keyword is to be included in a people-related search query as a search term, using the monitored people-related search requests;
generate a relevance score for the first keyword, using search results produced in response to the monitored people-related search requests, the relevance score expressing how likely a search that includes the first keyword as a search term is to produce a relevant result that originates from the on-line social network system; and
generate the first priority score for the first keyword utilizing the popularity score and the relevance score.

19. The system of claim 11, wherein the search request is directed to the on-line social network system or a third party search engine, the third party search engine and the on-line social network system provided by different entities.

20. A machine-readable non-transitory storage medium having instruction data executable by a machine to cause the machine to perform operations comprising:
detecting a people-related search request comprising a first keyword and a second keyword, the first keyword and the second keyword representing respective first and second people search results pages (PSERPs) provided by an on-line social network system;
accessing a first priority score assigned to the first keyword and a second priority score assigned to the second keyword;
generating respective ranking scores for search results retrieved in response to the people-related search request comprising the first keyword and the second keyword using the first priority score assigned to the first keyword and the second priority score assigned to the second keyword;
selecting a subset from the retrieved search results for presentation on a display device based on the generated respective ranking scores; and
generating a search results web page comprising the subset selected based on the generated respective ranking scores.
